(19) United States
(12) Patent Application Publication
(10) Pub. No.: US 2026/0106254 A1
(43) Pub. Date: Apr. 16, 2026

(54) BATTERY PROCESSING METHOD AND BATTERY PROCESSING SYSTEM

(71) Applicant: MAZDA MOTOR CORPORATION, Hiroshima (JP)

(72) Inventors: Susumu MINEOI, Hiroshima (JP); Tenyu YAN, Hiroshima (JP); Kenjiro MOMOSAKI, Hiroshima (JP); Tomoki YAMAMOTO, Hiroshima (JP)

(73) Assignee: MAZDA MOTOR CORPORATION, Hiroshima (JP)

(21) Appl. No.: 19/350,073

(22) Filed: Oct. 6, 2025

(30) Foreign Application Priority Data
Oct. 11, 2024 (JP) 2024-179277

(51) Int. Cl. H01M 10/54; C22B 26/12

(52) U.S. Cl. CPC H01M 10/54; C22B 26/12

(57) ABSTRACT

The battery processing method for processing the lithium-ion battery that includes a positive electrode material and a negative electrode material and is configured by laminating the positive electrode material and the negative electrode material in a lamination direction, and wherein gas is internally present, the battery processing method including: a gas extrusion step of extruding the gas toward a peripheral edge portion of the lithium-ion battery in a plane perpendicular to the lamination direction; and a cooling and charging step of depositing lithium on the negative electrode material by charging the lithium-ion battery while cooling.

### CROSS-REFERENCE TO RELATED APPLICATION

The present application claims priority to Japanese Patent Application 2024-179277, filed Oct. 11, 2024, the entire contents of which are incorporated herein by reference.

### FIELD

Embodiments relate to a battery processing method and a battery processing system.

### BACKGROUND

In recent years, lithium-ion batteries have been widely used as in-vehicle batteries of electric-powered vehicles such as electric vehicles and hybrid vehicles. The lithium-ion battery contains valuable substances including lithium. It is requested to recycle valuable substances from the used lithium-ion batteries for resource circulation.

Patent Literature 1 discloses a method for increasing an amount of lithium contained in a positive electrode material by discharging the used lithium-ion battery to collect lithium from the positive electrode material.

### Citation List

### Patent Literature

[Patent Literature 1] JP-A-2022-049831

### SUMMARY

The positive electrode material is generally configured by forming a positive electrode active material on a current collector foil such as aluminum. For example, in a case of a ternary system (NMC), the positive electrode active materials include the valuable substances such as nickel, manganese, and cobalt. In order to collect the valuable substances from the positive electrode active material, the positive electrode material is roasted together with a reducing agent and pulverized, and then a black mass or the like containing the positive electrode active material is selected. Next, the black mass is subjected to stepwise solvent extraction to sequentially extract manganese, cobalt, and nickel, and finally lithium is extracted. Thus, it takes time and effort to collect lithium in particular.

One or more embodiments may provide a battery processing method and a battery processing system capable of efficiently collecting lithium from a lithium-ion battery.

One or more embodiments may provide a battery processing method for processing a lithium-ion battery that includes a positive electrode material and a negative electrode material and is configured by laminating the positive electrode material and the negative electrode material in a lamination direction, wherein gas is internally present, the battery processing method including:
a gas extrusion step of extruding the gas toward a peripheral edge portion of the lithium-ion battery in a plane perpendicular to the lamination direction; and
a cooling and charging step of depositing lithium on the negative electrode material by charging the lithium-ion battery while cooling.

### ADVANTAGEOUS EFFECTS

According to an embodiment, lithium can be efficiently collected from a negative electrode of the lithium-ion battery.

### BRIEF DESCRIPTION OF DRAWINGS

FIG. 1 is a block diagram schematically illustrating a reuse system according to a first embodiment.

FIG. 2 is a perspective view illustrating a schematic configuration of a lithium-ion battery.

FIG. 3 is a cross-sectional view illustrating a schematic configuration of a battery cell.

FIG. 4 is a flowchart schematically illustrating a flow of reuse of the lithium-ion battery.

FIG. 5A is a schematic view schematically illustrating an example of a gas extrusion device according to the first embodiment.

FIG. 5B is a schematic view schematically illustrating an example of the gas extrusion device according to the first embodiment.

FIG. 5C is a schematic view schematically illustrating an example of the gas extrusion device according to the first embodiment.

FIG. 5D is a schematic view schematically illustrating an example of the gas extrusion device according to the first embodiment.

FIG. 5E is a schematic view schematically illustrating an example of the gas extrusion device according to the first embodiment.

FIG. 6 is a schematic view schematically illustrating an example of a cooling device according to the first embodiment.

FIG. 7 is a schematic view schematically illustrating an example of the cooling device and the gas extrusion device according to the first embodiment.

FIG. 8 is a graph illustrating a relationship between a charging rate and ease of deposition of lithium with respect to SOC at each cooling temperature.

### DETAILED DESCRIPTION

The present inventors have conducted intensive studies to efficiently collect lithium from a lithium-ion battery, and have found that lithium can be efficiently collected from the lithium-ion battery by intentionally generating lithium deposition (for example, dendrite), which is not desirable in a normal charging reaction, on a negative electrode material. Based on this finding, the present inventors have completed a battery processing method capable of efficiently collecting lithium from the lithium-ion battery.

A method for reusing a lithium-ion battery according to an embodiment includes
a battery processing method for processing a lithium-ion battery including a positive electrode material, a negative electrode material, and an electrolytic solution and configured by laminating the positive electrode material and the negative electrode material in a lamination direction, the battery processing method including:
a gas extrusion step of extruding gas generated in the lithium-ion battery toward a peripheral edge portion of the lithium-ion battery in an in-plane direction perpendicular to the lamination direction; and
cooling and charging of depositing lithium on the negative electrode material by charging the lithium-ion battery while cooling.

### First Embodiment

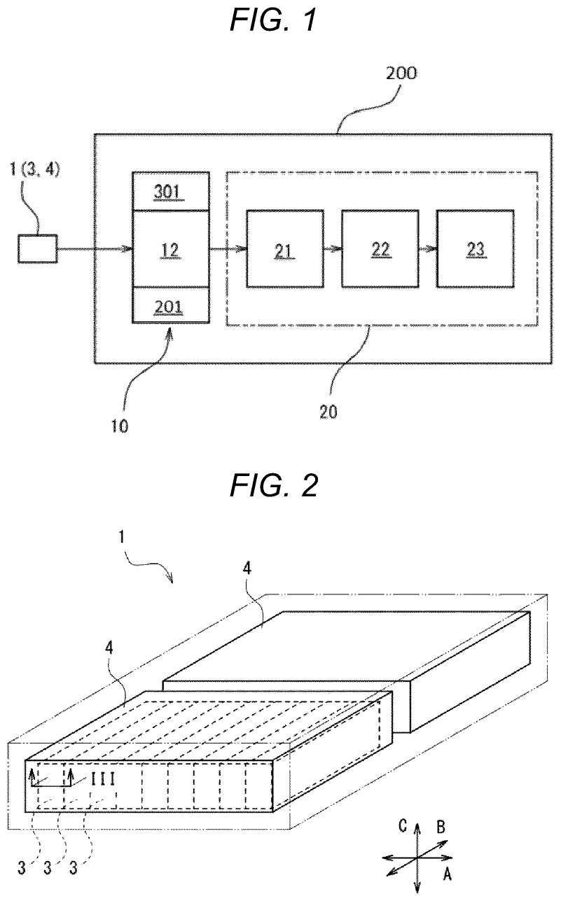

Hereinafter, a reuse system of a lithium-ion battery according to a first embodiment will be described with reference to the accompanying drawings. FIG. 1 is a block diagram schematically illustrating a reuse system 200 of a lithium-ion battery 1. As illustrated in FIG. 1, the reuse system 200 includes: a reuse unit 10 secondarily using the lithium-ion battery 1 that has been used primarily in an electric-powered vehicle, for example; and a recycle unit 20 collecting lithium from the lithium-ion battery 1 that has been used secondarily.

The reuse unit 10 reuses the lithium-ion battery 1, which has been used primarily, as an electrical storage device. In general, a deteriorated state of the lithium-ion battery for the electric-powered vehicle is determined on the basis of state of health (SOH) that indicates, for example, how much capacity is available in comparison with a new battery when the battery is fully charged. When it is determined that the lithium-ion battery 1 is inappropriate for use in the electric-powered vehicle on the basis of a degree of the deterioration, it is removed from the vehicle, and is used, in the reuse unit 10, as the electrical storage device for any of various secondary applications, such as a storage of renewable energy including solar power and wind power and a backup power source in the event of a disaster. For example, when the SOH becomes 70% or less, it may be determined that it is inappropriate for the primary use, that is, for use in the electric-powered vehicle.

The reuse unit 10 includes the lithium-ion battery 1, which is used secondarily as the electrical storage device, a charging device 12, a cooling device 201, and a gas extrusion device 301. The charging device 12 is configured to be able to charge the lithium-ion battery 1 in any appropriate charging pattern by adjusting a voltage and a current. For example, the lithium-ion battery 1 can be charged continuously at a predetermined voltage and a predetermined current, and can also be charged intermittently at the predetermined voltage and the predetermined current (also referred to as pulse charging). An upper limit of the charging voltage by the charging device 12 is a withstand voltage of the lithium-ion battery 1 or less, and is 4.3 V or less, for example. The cooling device 201 and the gas extrusion device 301 will each be described in detail after a description on a structure of the lithium-ion battery 1.

The recycle unit 20 includes: a disassembly device 21 that disassembles the lithium-ion battery 1 into a positive electrode material 31, a negative electrode material 35, and the like through a lithium deposition step described below when it is determined that the lithium-ion battery 1 can be inappropriate for the secondary use on the basis of the SOH, for example; an extraction device 22 that extracts lithium from the negative electrode material 35 after the disassembly; and a collection device 23 that collects extracted lithium. For example, when the SOH becomes 40% or less, it may be determined that it can be inappropriate for the secondary use.

FIG. 2 schematically illustrates the lithium-ion battery 1 that is mounted on the electric-powered vehicle. The lithium-ion battery 1 constitutes a battery pack having battery modules 4, each of which incorporates functions as a charge/discharge circuit, a cooling mechanism, and the like. Furthermore, the plural battery modules 4 are connected to each other and accommodated in a case. Each of the battery modules 4 is formed by connecting plural battery cells 3 in series or in parallel with each other, and is adjusted to desired capacity and a desired voltage.

The lithium-ion battery 1 is a rechargeable lithium-ion secondary battery. In the present specification, the term “lithium-ion battery” may collectively refer to the battery cell, the battery module, and the battery pack unless otherwise specified.

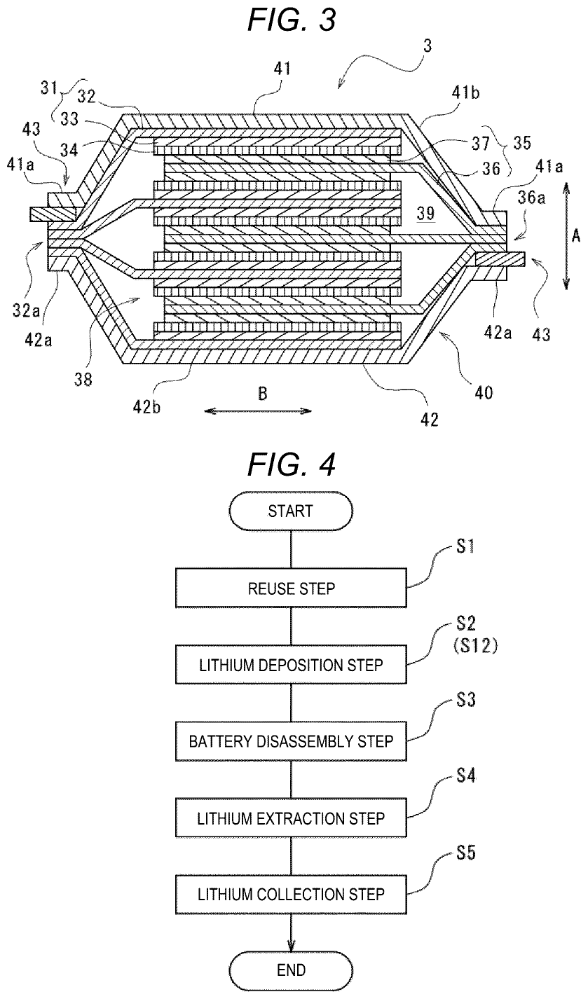

FIG. 3 is a cross-sectional view schematically illustrating the battery cell 3. As illustrated in FIG. 3, the battery cell 3 according to the present embodiment is of a laminated type. The battery cell 3 includes: a laminated electrode body 38 in which the positive electrode material 31, a separator 34, and the negative electrode material 35 are laminated in this order in a lamination direction A; and a case 40 that accommodates the laminated electrode body 38.

In the present embodiment, the laminated electrode body 38 is formed by laminating plural sets of the positive electrode material 31, the separator 34, and the negative electrode material 35 in the lamination direction A. The battery cell 3 has a rectangular shape that is elongated in a width direction B when viewed in the lamination direction A.

The positive electrode material 31 includes a positive electrode current collector 32 and a positive electrode active material 33 that is disposed on a surface of the positive electrode current collector 32 facing the separator 34. In a positive electrode current collector end portion 32a, the plural positive electrode current collectors 32 are connected to each other at one end (a left side in FIG. 3) in the width direction B that is orthogonal to the lamination direction. A metal foil suitable for a positive electrode can be suitably used for each of the positive electrode current collectors 32. A material that is used as a positive electrode active material of the lithium-ion secondary battery can be used as the positive electrode active material 33. In the present embodiment, each of the positive electrode current collectors 32 is made of aluminum, and the positive electrode active material 33 is made of NMC (nickel, manganese, and cobalt).

The negative electrode material 35 includes a negative electrode current collector 36 and a negative electrode active material 37 that is disposed on a surface of the negative electrode current collector 36 facing the separator 34. In a negative electrode current collector end portion 36a, the plural negative electrode current collectors 36 are connected to each other at the other end (a right side in FIG. 3) in the width direction B. A metal foil suitable for a negative electrode can be suitably used for each of the negative electrode current collectors 36. A material that is used as a negative electrode active material of the lithium-ion secondary battery can be used for the negative electrode active material 37. In the present embodiment, each of the negative electrode current collectors 36 is made of copper, and the negative electrode active material 37 is a carbon material (graphite) that has a layer structure.

The positive electrode active material 33 and the negative electrode active material 37 each contain an electrolytic solution 39. The electrolytic solution 39 is, for example, an organic solvent in which lithium ions can move. In the present embodiment, the electrolytic solution 39 contains dimethyl carbonate (DMC), ethylene carbonate (EC), and diethyl carbonate (DEC) in a volume ratio of 1:1:1, and contains lithium hexafluoride phosphate (LiPF₆) at a concentration of 1 mol/L.

The separator 34 is disposed between the positive electrode material 31 and the negative electrode material 35, and physically and electrically separates them from each other. The separator 34 may be a porous body having plural minute pores through which the lithium ions can pass. In the present embodiment, the separator 34 is a porous film that is made of polyolefin.

The case 40 includes a first case 41 and a second case 42 that are provided as a pair on both sides in the lamination direction A of the laminated electrode body 38. The first case 41 and the second case 42 are each formed to have a hat-shaped cross section. The first case 41 includes: a pair of flange portions 41a located at both ends in the width direction B; and a body portion 41b that is located between the paired flange portions 41a and bulges in a direction away from the second case 42 in the lamination direction A. Similarly, the second case 42 includes a pair of flange portions 42a and a body portion 42b that bulges in a direction away from the first case 41.

The first case 41 and the second case 42 are joined to each other in a state of sandwiching the positive electrode current collector end portion 32a and the negative electrode current collector end portion 36a between the flange portions 41a, 42a, and thereby constitute the case 40. That is, in a state where the laminated electrode body 38 is accommodated in the case 40, the positive electrode current collector end portion 32a and the negative electrode current collector end portion 36a are sandwiched between the paired flange portions 41a, 42a, and a remaining portion of the laminated electrode body 38 is accommodated in a space that is defined between the paired body portions 41b, 42b. In the state of being accommodated in the case 40, the laminated electrode body 38 is crimped with a predetermined pressure in the lamination direction A by the paired body portions 41b, 42b. An example of a tab 43 according to an embodiment is formed by a portion, which is sandwiched by the paired flange portions 41a, 42a, in the battery cell 3.

In the present embodiment, it is assumed that gas is generated inside the lithium-ion battery 1 that is determined not to be suitably used even in the secondary use. When the gas is generated inside the lithium-ion battery 1, external appearance of the lithium-ion battery 1 expands. Thus, the generation of the gas can be checked by the external appearance of the lithium-ion battery 1. In addition, since an internal pressure of the lithium-ion battery 1 fluctuates due to the generation of the gas, the generation of the gas can also be checked by fluctuation of a pressing force by the gas extrusion device 301 described below.

In general, when the gas is generated in the lithium-ion battery 1, transfer of electrons between the positive electrode material 31 and the negative electrode material 35 is inhibited by the gas, and thus a charging/discharging reaction is less likely to occur. The gas is a by-product that is generated from the electrolytic solution 39 by the charging/discharging reaction in the primary use and the secondary use of the lithium-ion battery 1. The gas is methane and/or carbon dioxide, for example.

Next, the gas extrusion device 301 will be described. The gas extrusion device 301 is a device that presses the battery cell 3 with a predetermined pressing force in the lamination direction A. In order to generate the charging/discharging reaction in the lithium-ion battery 1, the gas extrusion device 301 may be provided to the lithium-ion battery 1 that has been primarily used in the electric-powered vehicle, or may be provided to the lithium-ion battery 1 that has been secondarily used in the reuse unit 10. Alternatively, a gas extrusion device that can automatically or manually adjust the pressing force may be provided separately. The gas extrusion device 301 may be an appropriate actuator such as a hydraulic cylinder or a pneumatic cylinder can be used.

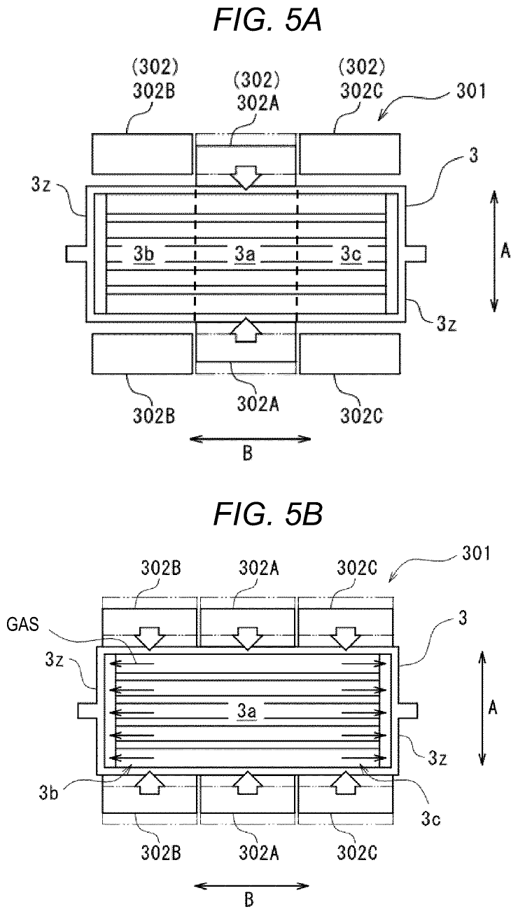

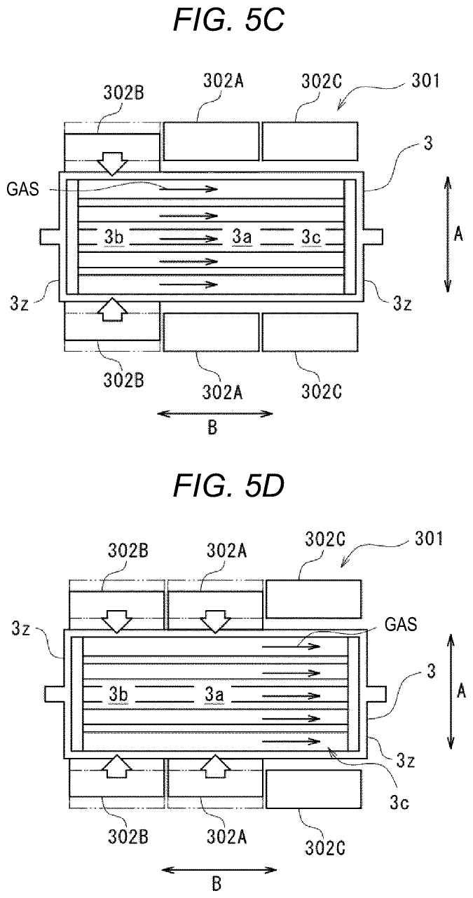

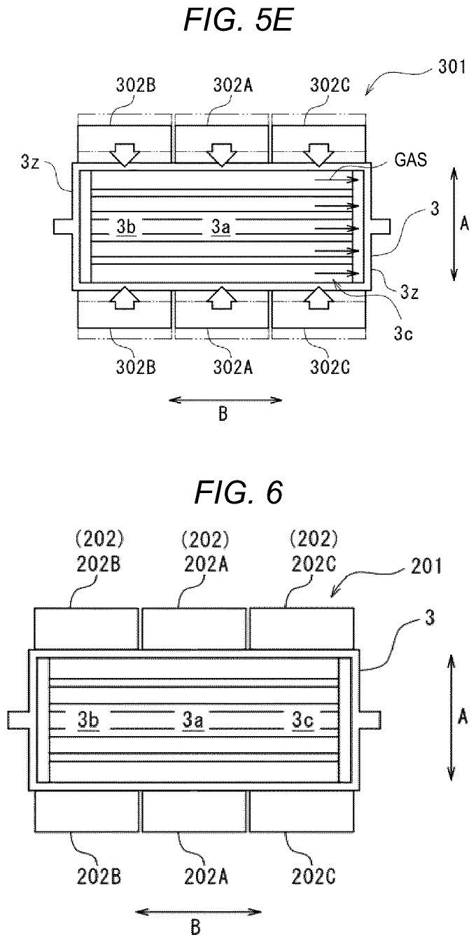

FIGS. 5A to 5E are views, each of which schematically illustrates the gas extrusion device 301. FIGS. 5A to 5E also schematically illustrate the battery cell 3 that is pressed by the gas extrusion device 301. As illustrated in FIG. 5A, the gas extrusion device 301 includes plural sets of presser pairs 302, each set of which is provided as a pair on both sides of the battery cell 3 in the lamination direction A, and which are divided in the width direction B of the battery cell 3. In the present embodiment, the gas extrusion device 301 includes: a central presser pair 302A located at a center in the width direction B; a one-side or first side presser pair 302B located on one side (a left side in FIG. 5A) in the width direction B; and another-side or second side presser pair 302C located on the other side (a right side in FIG. 5A) in the width direction B. The number of presser pairs 302 may be three, or two, four, or more.

Next, the cooling device 201 will be described. FIG. 6 is a view schematically illustrating the cooling device 201. FIG. 6 also schematically illustrates the battery cell 3 that is cooled by the cooling device. As illustrated in FIG. 6, a pair of the cooling devices 201 is provided on both sides of the battery cell 3 in the lamination direction A. In addition, it may be configured that a single cooler covers the entire battery cell 3 in the width direction B on one side of the paired cooling devices 201, or, as illustrated in FIG. 6, it may be configured to provide plural sets of cooler pairs 202 that are formed by dividing them in the width direction B of the battery cell 3. In the present embodiment, a central cooler pair 202A for cooling the central portion 3a of the battery cell 3 and cooler pairs 202B, 202C for respectively cooling both side portions 3b, 3c of the battery cell 3 are provided. When being divided, the number of cooler pairs 202 may be three, or may be two, four, or more. However, from a viewpoint of controlling a cooled portion according to the deteriorated state of the battery, it may be divided into three or more. For example, when the battery cell 3 is cooled only by the central cooler pair 202A, lithium is preferentially or selectively deposited on the negative electrode material 35 that is located in a central portion from an end portion in the width direction B. In an implementation, the cooler may be in the form of the pair, or may be disposed only on one side (an upper side or a lower side in FIG. 6) in the lamination direction A, for example.

The cooling device 201 may be a cooling device of any appropriate type. In the present embodiment, a thermostatic bath is adopted as the cooling device 201.

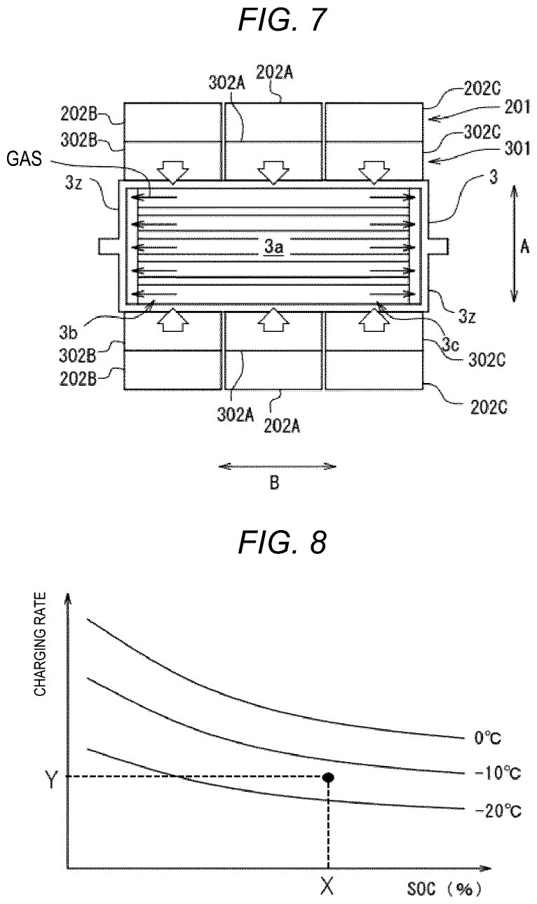

In addition, the cooling device 201 may be disposed to be in contact with the gas extrusion device 301. For example, as illustrated in FIG. 7, the cooling device 201 and the gas extrusion device 301 may each be provided in a pair on both sides of the battery cell 3 in the lamination direction A such that the cooling device 201 is disposed on an outer side. Alternatively, the cooling device 201 and the gas extrusion device 301 may each be provided in a pair on both sides of the battery cell 3 in the lamination direction A such that the cooling device 201 is disposed between the battery cell 3 and the respective gas extrusion device 301.

Next, reuse of the lithium-ion battery 1 will be described. FIG. 4 is a flowchart schematically illustrating a flow of reuse of the lithium-ion battery 1. As illustrated in FIG. 4, when it is determined that the lithium-ion battery 1, which is mounted on an electric-powered vehicle, is in the deteriorated state that is not suitable for use in the electric-powered vehicle on the basis of the SOH, for example, a reuse step (step S1) is executed. In the reuse step S1, the lithium-ion battery 1 is removed from the electric-powered vehicle and used secondarily in the reuse unit 10.

In a case where it is determined that the lithium-ion battery 1 is in a predetermined deteriorated state after being used secondarily as the electrical storage device, the lithium deposition step (step S2) is executed following the secondary use in the reuse unit 10. In the lithium deposition step, lithium is deposited on the negative electrode material 35. The lithium deposition step includes: a gas extrusion step S21 of extruding gas toward a peripheral edge portion of the lithium-ion battery in a plane perpendicular to the lamination direction; and a cooling and charging step S22 of depositing lithium on the negative electrode material 35 by charging the lithium-ion battery while cooling.

In the gas extrusion step S21, in regard to the battery cell 3, the gas generated in the battery cell 3 is extruded to a peripheral edge portion 3z side by sequentially operating the presser pairs 302 in the plural sets of the presser pairs 302 from one end portion 3b side to the other end portion 3c side in the width direction B or by sequentially operating them from the central portion 3a in the width direction B outwardly to both of the side portions 3b, 3c side in the width direction B. Accordingly, the battery processing method in the present embodiment further includes the gas extrusion step of extruding the gas toward the peripheral edge portion 3z of the battery cell 3 in an in-plane direction perpendicular to the lamination direction A.

In the gas extrusion step S21, the battery cell 3 is pressed at least with such a magnitude of the pressing force that allows the gas in the battery cell 3 to move. In the cooling and charging step S22 later, in order to generate the charging/discharging reaction in the lithium-ion battery 1, the pressing force may be 10 kPa or more and 1 MPa or less.

For example, as illustrated in FIG. 5A, after the central portion 3a of the battery cell 3 in the width direction B is pressed first, as illustrated in FIG. 5B, both of the side portions 3b, 3c in the width direction B may be additionally pressed. As a result, the gas is extruded from the central portion 3a side in the width direction B of the battery cell 3 to both of the side portions 3b, 3c side. Here, each of the portions 3a, 3b, 3c of the battery cell 3 remains pressed such that the extruded gas does not flow back to the central portion 3a or the like of the battery cell 3 again.

Further alternatively, as illustrated in FIG. 5C, after pressing of the one end portion 3b in the width direction B of the battery cell 3, the central portion 3a in the width direction may be additionally pressed as illustrated in FIG. 5D, and the other end portion 3c in the width direction B may be further additionally pressed as illustrated in FIG. 5E. As a result, the gas is extruded from the one end portion 3b side to the other end portion 3c side in the width direction B, e.g., the gas may be extruded by portion, e.g., by selectively and independently pressing different portions of the battery cell 3 at different times. Here, each of the portions 3a, 3b, 3c of the battery cell 3 remains pressed such that the extruded gas does not flow back to the central portion 3a or the like of the battery cell 3 again.

In a state where each of the portions 3a, 3b, 3c of the battery cell 3 is pressed in the gas extrusion step S21, the cooling and charging step (step S22) of depositing lithium on the negative electrode material 35 is performed. In the cooling and charging step S22, the lithium-ion battery 1 is charged to deposit lithium on the negative electrode material 35.

In the gas extrusion step S21, the battery cell 3 is locally pressed by operating at least some presser pairs 302 among the plural sets of the presser pairs 302. Accordingly, in the gas extrusion step S21, the battery cell 3 is pressed by increasing the pressing force in the lamination direction A on at least a part thereof in comparison with a remaining portion, e.g., the battery cell 3 is divided into portions in the lamination direction A, and the different portions are sequentially pressed in order to extrude the gas outwardly at sides of the battery cell 3. In general, in order to generate the charging/discharging reaction in the lithium-ion battery 1, the battery cell 3 has to be pressed (that is, constrained) in the lamination direction. In the gas extrusion step S21, the battery cell 3 is pressed with the pressing force for at least generating the charging/discharging reaction. For example, the pressing force is 10 kPa or more and 1 MPa or less.

After completion of the gas extrusion step S21, and before being subjected to the cooling and charging step S22, the battery cell 3 may keep being pressed, or pressing thereof may be canceled or released. In an implementation, after the completion of the gas extrusion step S21, and before being subjected to the cooling and charging step S22, the battery cell 3 stops being pressed.

Next, in the cooling and charging step 22, the lithium-ion battery 1 is charged while being cooled by the cooling device 201 under a predetermined cooling condition. Here, a graph in FIG. 7 illustrates a relationship between a charging rate (a charging current), at which lithium starts being deposited, and state of charge (SOC) at each temperature. More specifically, when charging is performed on a curve or in a region above the curve at each temperature, lithium is easily deposited on the negative electrode material 35. The SOC is an index indicating a charged state of the battery, and indicates battery capacity at the time when a fully charged state is set as 100% and a completely discharged state is set as 0%. As illustrated in FIG. 8, lithium is more likely to be deposited as the SOC of the lithium-ion battery 1 is increased and/or as the temperature thereof is reduced.

The cooling temperature varies by a use environment, a type, and the like of the lithium-ion battery 1. However, when the lithium-ion battery 1 is of a so-called capacitive type (also referred to as an energy type) that is mounted on an electric vehicle, for example, it can be 20° C. or less, 10° C. or less, 0° C. or less, −5° C. or less, −10° C. or less, −20° C. or less, or −30° C. or less, and can be −50° C. or more, −40° C. or more, −30° C. or more, −25° C. or more, or −20° C. or more. From a viewpoint of reliably depositing lithium on a cooled portion, the temperature may be −10° C. or less. In addition, in order to prevent the deposition of lithium on the entire lithium-ion battery 1 due to excessive cooling, the cooling temperature may be −50° C. or more or −40° C. or more. In one aspect, the cooling temperature can be from −40° C. to 10° C.

A cooling rate during cooling may be 0.1°C./min to 50°C./min, for example. From a viewpoint of unevenly distributing deposition positions of lithium, the cooling rate may be 1°C./min to 50°C./min. In the present disclosure, the “cooling rate” is a parameter that is based not on a temperature of a surrounding environment but on a temperature inside the battery.

Thus, in the cooling and charging step 22, the lithium-ion battery 1 is charged while being cooled.

As a result, lithium can be deposited on a part of the negative electrode material 35 without high-rate charging, and the charging current can be suppressed. Thus, energy can be saved.

Meanwhile, in the cooling and charging step 22, in a case where charging, which is performed while only a part of the lithium-ion battery 1 is cooled, is not the high-rate charging, there is a possibility that the deposition of lithium in the cooled portion is suppressed due to progress of the normal charging reaction in an uncooled portion. Thus, charging may be performed by the high-rate charging.

Here, in the cooling and charging step 22, the lithium-ion battery 1 only needs to be charged in a cooled state. Cooling of the lithium-ion battery 1 by the cooling device 201 and charging of the lithium-ion battery 1 by the charging device 12 may be started simultaneously, or one thereof may be started first. That is, after cooling by the cooling device 201 is performed, the charging device 12 may perform charging while the cooling state by the cooling device 201 is maintained.

In the present specification, the high-rate charging means charging with such a large current that intentionally generates lithium on the negative electrode material 35 during charging.

When the charging current in the high-rate charging becomes excessively large, unfavorable side reactions, such as gasification of the electrolytic solution 39 and deformation and damage of each component, possibly occur due to heat generation. Thus, from a viewpoint of energy saving, excessive charging current is not preferable. For example, when the lithium-ion battery 1 is of the capacitive type, an upper limit of the charging current may be set to about 3 C. Meanwhile, when the lithium-ion battery 1 is of a high-output type, the upper limit of the charging current may be set to about 20 C.

For example, when the lithium-ion battery 1 is of the capacitive type, it may be charged with a current of 2 C or more, for example. Meanwhile, when being of the so-called high-output type (also referred to as a power type) that is mounted on a hybrid vehicle, the lithium-ion battery 1 may be charged with a current of 10 C or more, for example. Here, the current of 1 C means a current that is required to fully charge each of the lithium-ion batteries in one hour. Lithium can be deposited further efficiently on the negative electrode material 35 by the continuous high-rate charging for a predetermined time.

Alternatively, in the cooling and charging step 22, charging may be performed by the pulse charging. In a case of normal charging (also referred to as continuous charging) that is not the pulse charging, the normal charging reaction can also occur along with the deposition of lithium. Meanwhile, when the lithium-ion battery 1 is subjected to the pulse charging having instantaneously higher output than that of the continuous charging, a large amount of energy is consumed in a lithium deposition reaction that requires the high energy. Thus, it is possible to efficiently deposit the larger amount of lithium than that in the normal charging reaction.

Pulse charging conditions vary by the use environment, the type, and the like of the lithium-ion battery 1. For example, when the lithium-ion battery 1 is of the so-called capacitive type that is mounted on the electric vehicle, a frequency can be 0.1 to 100 Hz, e.g., 0.1 to 10 Hz, or 0.1 to 1 Hz. In addition, the voltage of the pulse charging can be from 3.8 to 4.3 V.

The pulse charging may be performed by high-rate pulse charging. In the present specification, the high-rate pulse charging means charging with such a large current that intentionally generates lithium on the negative electrode material 35 during the pulse charging.

For example, when being of the capacitive type, the lithium-ion battery 1 may be subjected to the pulse charging with the current of 2 C or more, for example. Meanwhile, when being of the so-called high-output type (also referred to as the power type) that is mounted on the hybrid vehicle, the lithium-ion battery 1 may be subjected to the pulse charging with the current of 10 C or more, for example. Here, the current of 1 C means the current that is required to fully charge each of the lithium-ion batteries in one hour. Lithium can be deposited further efficiently on the negative electrode material 35 by the intermittent high-rate pulse charging for a predetermined time.

When the charging current in the high-rate pulse charging becomes excessively large, the unfavorable side reactions, such as the gasification of the electrolytic solution 39 and the deformation and the damage of each of the components, possibly occur due to the heat generation. Thus, from the viewpoint of the energy saving, excessive charging current is not preferable. For example, when the lithium-ion battery 1 is of the capacitive type, the upper limit of the charging current may be set to about 3 C. Meanwhile, when the lithium-ion battery 1 is of the high-output type, the upper limit of the charging current may be set to about 20 C.

Next, the lithium-ion battery 1 is removed from the reuse unit 10, and a battery disassembly step (step S3) is executed by the disassembly device 21. In the battery disassembly step, the lithium-ion battery 1 is disassembled into components such as the positive electrode material 31, the separator 34, the negative electrode material 35, and the case 40. When only collection of lithium is intended, at least the negative electrode material 35 may only be disassembled.

Next, a lithium extraction step (step S4) is executed. In the lithium extraction step S4, lithium is extracted from the disassembled negative electrode material 35. In the lithium extraction step S4, after the negative electrode material 35 is exuded with water, which is then filtered, the extraction device 22 removes the negative electrode current collector 36 and the negative electrode active material 37 from the negative electrode material 35, and thereby extracts an aqueous solution containing lithium ions.

In addition, in the disassembled negative electrode material 35, a portion having a larger lithium deposition amount than the other portions in the lithium deposition step S2 or a lithium deposition step S12 described below is preferentially subjected to the lithium extraction step S4. In this way, lithium may be extracted efficiently.

Finally, a lithium collection step (step S5) is executed to collect lithium from the aqueous solution containing the lithium ions. In the lithium collection step, after subjecting lithium to a solution treatment with carbonated water, the collection device 23 filters the solution and collects lithium as lithium carbonate.

That is, the battery processing method according to the present embodiment is
the battery processing method for processing the lithium-ion battery 1 that includes the positive electrode material 31 and the negative electrode material 35, and includes:
the lithium deposition step S2 of depositing lithium on the negative electrode material 35 by charging the lithium-ion battery 1;
the battery disassembly step S3 of disassembling at least the negative electrode material 35 from the lithium-ion battery 1; and
a lithium collection step S5 of collecting lithium from the negative electrode material 35.

As a result, since the negative electrode material 35 is generally formed by laminating graphite on the current collector foil, such as copper, in the form of the layer, it contains less types of valuable substances than the positive electrode material 31 that has plural types of the valuable substances such as cobalt, nickel, and manganese. Accordingly, unlike a case where lithium is collected from the positive electrode material 31, it does not require time and effort for stepwise solvent extraction of plural types of the valuable metals. Thus, lithium can be efficiently collected from the negative electrode material 35.

In the first embodiment described above, the description has been made on, as the example, the case where the lithium deposition step is executed after the lithium-ion battery 1 in the form of the battery pack is subjected to the reuse step S1. The lithium-ion battery 1 in the form of the battery module 4 or the battery cell 3 may be subjected to the reuse step S1 and/or the lithium deposition step.

### Second Embodiment

A second embodiment differs in that the second lithium deposition step S12 is adopted instead of the lithium deposition step S2 according to the first embodiment. In the second lithium deposition step S12, a second cooling and charging step S23 is adopted instead of the cooling and charging step S22.

In the second cooling and charging step S23, the plural cooled portions may further be included in the plane perpendicular to the lamination direction, or cooling and charging may be sequentially performed for each of the cooled portions. In the present embodiment, the cooled portions of the lithium-ion battery 1 are sequentially cooled. In the present disclosure, the “cooled portion” refers to a part of the lithium-ion battery 1 to be cooled.

In the second cooling and charging step 23, cooling may be performed under a different condition for each of the cooled portions according to the deteriorated state of the respective cooled portion. For example, in the second cooling and charging step 23, the cooling portion may be performed by increasing the pressing force in the lamination direction to be larger than that on the remaining cooled portions. As illustrated in FIG. 7, the presser pair 302 that is associated with the cooler pair 202 achieves the increase in the pressing force on the cooled portion. By cooling and pressing the portion of the negative electrode material 35, from which the deposition of the larger amount of lithium is desired, lithium can be deposited efficiently. For example, in a case where the deteriorated state of the central portion 3a is more severe than those of both of the side portions 3b, 3c of the battery cell 3, in the second cooling and charging step 23, the central portion 3a is cooled while being pressed. As a result, lithium can be deposited preferentially in the central portion 3a.

With reference to FIG. 1, similar to the reuse system 200 according to the first embodiment, the reuse system 200 according to the second embodiment includes the cooling device 201 and the extrusion device 301, and the lithium-ion battery 1 is provided in the form of the battery cell 3 to the reuse unit 10.

In the second embodiment, the description has been made on, as the example, the case where the second lithium deposition step S12 is executed after the lithium-ion battery 1 in the form of the battery cell 3 is subjected to the reuse step S1. The lithium-ion battery 1 in the form of the battery pack or the battery module 4 may be subjected to the reuse step S1 and/or the second lithium deposition step S12. In this case, the cooling device 201 may be installed in the battery pack or the battery module 4 in advance.

The reuse system 200 of the lithium-ion battery 1 according to the present disclosure may correspond to the configurations described in the above embodiments, or various modifications can be made thereto.

In the above embodiment, the description has been made on the example in which the lithium-ion battery is of the laminated type. For example, a lithium-ion battery in a cylindrical shape or a polygonal shape may be adopted, which is formed by winding a belt-shaped laminated electrode body, in which a belt-shaped positive electrode material, a belt-shaped separator, and a belt-shaped negative electrode material are laminated in the lamination direction A, in a cylindrical shape or a polygonal shape. In a case of the cylindrical shape or the polygonal shape, the lamination direction corresponds to a radial direction orthogonal to a winding direction.

Although the description has been made on a cell-by-cell basis, it may be implemented on a module-by-module basis or on a battery pack-by-battery pack basis. In a case of the implementation on the battery pack-by-battery pack basis, the gas extrusion device, the cooling device, and the like may be provided in the battery pack in advance.

### Additional Remarks

According to the reuse system 200 of the lithium-ion battery 1 in the present disclosure, the following aspects are provided.

### First Aspect

The battery processing method for processing the lithium-ion battery that includes the positive electrode material and the negative electrode material and is configured by laminating the positive electrode material and the negative electrode material in the lamination direction, wherein the gas is internally present, the battery processing method including:
the gas extrusion step of extruding the gas toward the peripheral edge portion of the lithium-ion battery in the plane perpendicular to the lamination direction; and
the cooling and charging step of depositing lithium on the negative electrode material by charging the lithium-ion battery while cooling.

### Second Aspect

The battery processing method according to the first aspect, in which
in the gas extrusion step, the gas is extruded from the central portion of the lithium-ion battery in the plane.

### Third Aspect

The battery processing method according to the first or second aspect, in which
the lithium-ion battery further includes plural cooled portions in the plane perpendicular to the lamination direction, and
in the cooling and charging step, the cooling and the charging are sequentially performed for each of the cooled portions.

### Fourth Aspect

The battery processing method according to the third aspect, in which
in the cooling and charging step, the cooling is performed under different cooling conditions for each of the cooled portions according to the deteriorated state of the respective cooled portion.

### Fifth Aspect

The battery processing method according to the third or fourth aspect, in which
in the cooling and charging step, the cooled portion is performed by increasing the pressing force in the lamination direction to be larger than that on the remaining cooled portion during the cooling.

### Sixth Aspect

The battery processing method according to any one of the first to fifth aspects, in which
in the cooling and charging step, the charging is performed by pulse charging.

### Seventh Aspect

The battery processing method according to any one of the first to sixth aspects further including:
the battery disassembly step of disassembling at least the negative electrode material from the lithium-ion battery; and
the lithium extraction step of extracting the lithium from the negative electrode material.

### Eighth Aspect

The battery processing system for processing the lithium-ion battery including the positive electrode material, the negative electrode material, and the electrolytic solution and configured by laminating the positive electrode material and the negative electrode material in the lamination direction, the battery processing system including:
the gas extrusion device capable of pressing the lithium-ion battery by portion;
the cooling device capable of cooling the lithium-ion battery by portion; and
the charging device capable of charging the lithium-ion battery.

### Ninth Aspect

The battery processing system according to the eighth aspect, in which
the gas extrusion device can extrude the gas to the peripheral edge portion side of the lithium-ion battery by sequentially pressing the gas in the lamination direction under the predetermined pressing condition.

### Tenth Aspect

The battery processing system according to the eighth or ninth aspect, in which
the charging device is a charging device capable of performing pulse charging.

### Reference Signs List

1: lithium-ion battery
3: battery cell
4: battery module
10: reuse unit
12: charging device
20: recycle unit
21: disassembly device
22: extraction device
23: collection device
31: positive electrode material
34: separator
35: negative electrode material
38: laminated electrode body
39: electrolytic solution
40: case
200: reuse system
201: cooling device
301: gas extrusion device

1. A battery processing method for processing a lithium-ion battery that includes a positive electrode material and a negative electrode material and is configured by laminating the positive electrode material and the negative electrode material in a lamination direction, wherein gas is internally present, the battery processing method comprising:
a gas extrusion step of extruding the gas toward a peripheral edge portion of the lithium-ion battery in a plane perpendicular to the lamination direction; and
a cooling and charging step of depositing lithium on the negative electrode material by charging the lithium-ion battery while cooling the lithium-ion battery.

2. The battery processing method according to claim 1, wherein, in the gas extrusion step, the gas is extruded from a central portion of the lithium-ion battery in the plane perpendicular to the lamination direction.

3. The battery processing method according to claim 1, wherein:
the lithium-ion battery further includes a plurality cooled portions that are arranged in the plane perpendicular to the lamination direction, and
in the cooling and charging step, the cooling and the charging are sequentially performed on each cooled portion of the plurality cooled portions.

4. The battery processing method according to claim 3, wherein, in the cooling and charging step, the cooling is performed under a different cooling condition for each of the cooled portions according to a deteriorated state of the respective cooled portion.

5. The battery processing method according to claim 3, wherein the cooling and charging step further includes increasing a pressing force in the lamination direction of the cooled portion to be larger than a pressing force on a remaining cooled portion during the cooling.

6. The battery processing method according to claim 1, wherein, in the cooling and charging step, the charging is performed by pulse charging.

7. The battery processing method according to claim 6, wherein the gas extrusion device includes a plurality of presser pairs, each presser pair is on opposite sides of the lithium-ion battery in the lamination direction, and each presser pair is divided in a width direction of the lithium-ion battery.

8. The battery processing method according to claim 7, wherein the plurality of presser pairs includes a central presser pair located at a center in the width direction of the lithium-ion battery; a first side presser pair located on one side of the lithium-ion battery in the width direction; and a second side presser pair located on another side of the lithium-ion battery in the width direction of the lithium-ion battery.

9. The battery processing method according to claim 1, further comprising:
a battery disassembly step of disassembling at least the negative electrode material from the lithium-ion battery; and
a lithium extraction step of extracting the lithium from the negative electrode material.

10. The battery processing method according to claim 1, wherein the gas extrusion step includes extruding the gas with a gas extrusion device that presses the lithium-ion battery with a predetermined pressing force in the lamination direction.

11. A battery processing system for processing a lithium-ion battery including a positive electrode material, a negative electrode material, and an electrolytic solution and configured by laminating the positive electrode material and the negative electrode material in a lamination direction, the battery processing system comprising:
a gas extrusion device configured to independently press different portions of the lithium-ion battery;
a cooling device configured to independently cool different portions of the lithium-ion battery; and
a charging device configured to charge the lithium-ion battery.

12. The battery processing system according to claim 11, wherein the gas extrusion device is configured to extrude gas inside the battery toward a peripheral edge portion side of the lithium-ion battery by sequentially pressing in the lamination direction under a predetermined pressing condition.

13. The battery processing system according to claim 11, wherein the charging device is configured to charge the lithium-ion battery by performing pulse charging.

14. The battery processing system according to claim 11, wherein the gas extrusion device includes a plurality of presser pairs, each presser pair is on opposite sides of the lithium-ion battery in the lamination direction, and each presser pair is divided in a width direction of the lithium-ion battery.

15. The battery processing system according to claim 14, wherein the plurality of presser pairs includes a central presser pair located at a center in the width direction of the lithium-ion battery; a first side presser pair located on one side of the lithium-ion battery in the width direction; and a second side presser pair located on another side of the lithium-ion battery in the width direction of the lithium-ion battery.
